(19) United States
(12) Patent Application Publication
(10) Pub. No.: US 2024/0070664 A1
(43) Pub. Date: Feb. 29, 2024

(54) METHOD FOR COMPUTER-IMPLEMENTED SERVICE PROVISION IN A BLOCKCHAIN, CORRESPONDING BLOCKCHAIN NETWORK NODE AND COMPUTER PROGRAM

(71) Applicant: Orange, Issy-Les-Moulineaux (FR)

(72) Inventors: Nassim LAGA, Chatillon Cedex (FR); Tiphaine HENRY, Chatillon Cedex (FR)

(21) Appl. No.: 18/271,427

(22) PCT Filed: Jan. 6, 2022
(86) PCT No.: PCT/FR2022/050032

§ 371 Date: Jul. 7, 2023

(30) Foreign Application Priority Data
Jan. 7, 2021 (FR) FR2100122

(51) Int. Cl. G06Q 20/38; G06Q 20/40

(52) U.S. Cl. CPC G06Q 20/389; G06Q 20/401

(57) ABSTRACT

A method for a computer-implemented service provision in a blockchain. The method includes, implemented by a smart contract of the blockchain: receiving a service request, the request including at least one service selection criterion and at least one quality of service rule; identifying at least one service offer that meets the at least one service selection criterion, referred to as candidate service offer, from among service offers recorded in the blockchain; sending at least one of the candidate service offers, the at least one sent service offer being selected on the basis of the at least one quality of service rule on the one hand, and of a history of services, associated with the candidate service offers, and recorded in the blockchain, on the other hand.

### CROSS-REFERENCE TO RELATED APPLICATIONS

This application is filed under 35 U.S.C. § 371 as the U.S. National phase of application No. PCT/FR2022/050032 entitled “METHOD FOR COMPUTER-IMPLEMENTED SERVICE PROVISION IN A BLOCKCHAIN, CORRESPONDING BLOCKCHAIN NETWORK NODE AND COMPUTER PROGRAM” and filed Jan. 6, 2022, and which claims priority to FR 2100122 filed Jan. 7, 2021, each of which is incorporated by reference in its entirety.

### BACKGROUND

### Technical Field

The field of the development is that of computer-implemented technologies, and more particularly, the exchange of goods or services based on a blockchain information decentralised storage technology. More specifically, the development relates to a mechanism, implemented by a smart contract of a blockchain, for the selection and decentralised connection of a service provider and a customer.

### Description of the Related Art

Blockchain is a transparent, secure information storage and transmission technology that operates without a central control body. More precisely, a blockchain is a distributed database that contains the history of all exchanges between its users since its creation: information sent by users and exchanges within the database are verified and grouped at regular intervals of time into blocks, thus forming a chain. All of this is secured by cryptography.

More precisely, transactions between the network users are grouped into blocks. Each block is validated by the network nodes, using cryptographic techniques that depend on the type of blockchain. Once the block is validated, it is time-stamped and added to the blockchain, that is accessible to all users. The transaction is then visible to the recipient, as well as to all the nodes of the network. Once a block has been added to the chain, it can no longer be changed or deleted, which guarantees the authenticity and security of the network.

There are public blockchains, which are open to all, and private or consortium blockchains, whose access and use are limited to a certain number of predefined stakeholders.

The first blockchains found applications in the field of digital currency, such as bitcoin, which is an example of a programmable currency. However, the decentralised nature of the blockchain, coupled with its security and transparency, suggests much broader applications than just the currency field.

Blockchain infrastructures have recently been enriched with “smart contracts”, that can be defined as autonomous programs that automatically perform the terms and conditions of a contract, without requiring any human intervention. In other words, a smart contract is a compiled computer program that carries a set of features allowing it to perform automatically and autonomously at least some of the specific clauses of the contract it carries. The emergence of these smart contracts opens up new applications for blockchains, particularly in the exchange of goods and services.

Indeed, the use of marketplaces (i.e., platforms that connect a service provider and a service requester) for outsourcing tasks has so far encountered a number of technical problems, to which the blockchain infrastructure, coupled with the use of smart contracts, could provide effective solutions:
faltering digitisation: the range of users of the platform can be large and diverse, which often implies that the connection platform should preferably be easy to use and accessible. In addition, it should enable stakeholders to ensure that current standards and regulations are complied with, for the electronic generation of contracts for example. It must also take into account the heterogeneity of the information systems of the systems involved;
lack of transparency in data management: to date, connection is most often performed by centralised third-party platforms. The latter are often prone to a lack of transparency with regard to the storage of stakeholder information. They can also resell for their own account the information extracted from the aggregation of event traces. This imbalance in the relations can thus favour certain monopolies, at the expense of transparent governance;
long and tedious procedures: the burden of procedures is often pointed out. Some steps may be redundant, inappropriate, lead to information redundancy. This burden of procedures generates fatigue and a cost in monetary and time resources. Furthermore, the offer publishing, connection, contracting and paying steps lead to a fragmented interfacing of each step. This involves delays in performance;
inflexible processes: the unitary treatment of tasks, the difficulty to access the data on tasks in progress, the variable quality of connection logs, and the tedious aspect of task generation, limit the optimisation of resources, for example for rerouting. In this context, a flexible task assignment is therefore difficult to imagine.

In order to address these various issues, it has been envisaged, in some specific areas such as energy management or allocation of computing resources, to design connection platforms using a blockchain infrastructure.

For example, in the field of computational task delegation, Wang et al. propose, in the paper “Permissioned blockchain for efficient and secure resource sharing in vehicular edge computing” (arXiv preprint arXiv:1906.06319), to use a blockchain and smart contract technique for efficient and secure resource sharing in the field of vehicular edge computing.

Yan et al., in the paper “Nebula: A blockchain based decentralised sharing computing platform” (ln: International Conference on Blockchain and Trustworthy Systems. pp. 715-731. Springer (2019)), for their part, propose a decentralised platform based on a blockchain technology for sharing computing resources.

In both cases, the assignment of computational tasks to available resources is performed according to a best distribution algorithm. In particular, Yan et al. propose to use the Hungarian algorithm to solve this assignment problem.

In the field of smart grids, the following work can be cited:
Troncia et al. (2019), “Distributed ledger technologies for peer-to-peer local markets in distribution networks”, Energies, 12(17), 3249;
Li, et al. (2017), “Consortium blockchain for secure energy trading in industrial internet of things”, IEEE transactions on industrial informatics, 14(8), 3690-3700;
Myung, et al. “Ethereum smart contract-based automated power trading algorithm in a microgrid environment”, The Journal of Supercomputing76(7), 4904-4914 (2020).

These connection platforms are based on an assignment of the resources to the tasks through a double auction mechanism that places the main emphasis on the price in the negotiation phases.

While these various solutions of the prior art are interesting in that they show the value of using blockchains and smart contracts in a context of connecting service providers and customers, they do not address all the problems mentioned above.

In particular, these connection platforms are all dedicated to specific use cases, and therefore offer little or no modularity. In addition, the resource selection and sorting algorithms are not optimal, in the sense that the task or resource is almost always assigned to the first bidder.

There is therefore a need for a technique for connecting service providers and customers, or tasks and resources, that does not have all the various drawbacks of the prior art, and that aims to address at least some of these various issues. In particular, there is a need for such a technique that helps, for example, a decentralised, transparent and/or objective connection of a resource to a specific need. There is also a need for such a technique that helps, for example, to reduce contracting and payment delays compared to connection platforms of the prior art. There is still a need for such a technique that is advantageously based on a blockchain and smart contract infrastructure. Finally, there is a need for such a technique that helps to improve the selection and sorting accuracy of the various service offers in order to optimise the connection of customers and suppliers.

### SUMMARY

The development responds to these various needs by proposing a method for computer-implemented service provision in a blockchain. According to the development, such a method comprises steps, implemented by a smart contract of the blockchain, of:
receiving a service request, the request comprising at least one service selection criterion and at least one quality of service rule;
identifying at least one service offer that meets said at least one service selection criterion, referred to as candidate service offer, from among service offers recorded in the blockchain;
sending at least one of the candidate service offers, said at least one sent service offer being selected on the basis of said at least one quality of service rule on the one hand, and of a history of services, associated with the candidate service offers, and recorded in the blockchain, on the other hand.

Thus, the development is based on a completely new and inventive approach to connecting principals and service providers, based on a blockchain technology. Indeed, the method according to the development allows, in an embodiment, to connect tasks and resources in a transparent and objective manner. Unlike techniques of the prior art, the selection of candidate service offers can be performed in a transparent and objective manner, based on a history securely and unforgeably recorded in the blockchain, and on the basis of selection criteria set in the service request. In at least some embodiments, the implementation of a blockchain can help to ensure the integrity of the data relating to the quality of service associated with the various service offers, which can help to select a candidate service offer adapted to the service request based on reliable and objective quality of service criteria (for example, the most suitable service offer for the service request).

Moreover, using the blockchain smart contract technology can reduce the contracting and payments delays, through the autonomous application of these rules when performing the service.

In some embodiments, said smart contract implements receiving a plurality of service requests.

In some embodiments, said smart contract implements receiving a plurality of service requests transmitted by a plurality of client devices of said communication network.

In some embodiments, at least one client device transmitting said at least one service request and/or at least one device providing at least one of said service offers recorded in said blockchain interact(s) with said smart contract via at least one API (Application Programming Interface) request using at least one function implemented by said smart contract and belonging to the following group:
a function for recording at least one service request and/or at least one service offer in said blockchain;
a function for filtering recorded service offers according to at least one service selection criterion comprised in at least one service request;
a function for sorting service offers that meet the at least one selection criterion comprised in at least one service request;
a function for establishing a contract between a device providing at least one of said service offers and a client device transmitting at least one of said service requests;
a function for recording in said blockchain a quality of service corresponding to a provided service.

In some embodiments, said functions of said smart contract implement consensus rules.

According to a first aspect, the sent service offers are sorted according to a quality of service score calculated for a candidate service offer, from said at least one quality of service rule on the one hand, and the history of services, associated with the candidate service offer. It is thus very easy for the customer to select wisely and objectively the best service offer, according to their choice criteria.

Indeed, according to another aspect, said at least one quality of service rule is a weighted combination of service selection criteria recorded in the blockchain. The customer can thus assign greater weights to the criteria that are most important to them, and easily identify the offer most likely to meet their expectations.

In yet another aspect, the service request also comprises a service request validity period. Thus, upon expiration of this time period, consideration of the service request automatically stops.

According to a complementary aspect, the identification of candidate service offers is iterated, according to a retry periodicity parameter associated with the service request for example, and until the end of the validity period, as long as no candidate service offer has been identified. The retry periodicity parameter can advantageously be defined, by the customer or directly within the blockchain, in order to optimise the connection between the principal and the service provider. In such an embodiment, the originator of the service request can thus be assured that a candidate service offer is searched as long as their need has not been met.

According to one embodiment, a service of the history can be recorded in the blockchain in association with a set of values assigned to the service selection criteria for the service. Thus, all performing conditions of services past can be securely and unforgeably recorded in the blockchain, which constitutes an effective assurance for the service request originator of the reliability of the candidate service offer assessment.

According to one embodiment, the quality of service score is calculated by means of the weighted or exponential moving average of the values of the services of the history, based on the at least one quality of service rule.

In particular, when assessing the candidate service offers, the quality of service score is for example calculated by means of the weighted average of the values of the selection criteria included in the quality of service rule. After the service has been performed, the quality of service score associated with the selected service offer is updated, for example, by calculating a weighted or exponential moving average, so as for example to give more importance to the most recently provided services, but without removing the effect of the values of the oldest services.

According to another feature, upon election of one of the sent candidate service offers, the method according to an embodiment of the development implements a step of generating a contract binding the service request and the elected service offer, and a step of recording the contract in the blockchain. These steps can notably be performed autonomously by the smart contract of the blockchain, which can help improve their speed of performance, compared to some techniques of the prior art.

In yet another aspect, after provision of the required service, the method comprises the steps of:
receiving and recording, in the blockchain, values assigned to the service selection criteria for the service provided;
updating, in the blockchain, a status of the required service.

Thus, each time a new service is provided, its performance conditions are unforgeably recorded in the blockchain, which allows the quality of service associated with each service offer to be recorded in full, and thus constitutes an assurance, for a service request originator, that the selection of a candidate service offer is based on objective criteria, in particular according to an actual service history.

According to another aspect, the service request also comprises at least one service provision incentive contextual parameter, and upon election of one of the sent candidate service offers, the method implements a step of staking the service provision incentive, in the blockchain. Such an incentive can for example consist in a deposit or a bonus, that advantageously encourages the service provider to offer the best possible quality of service.

In yet another aspect, depending on the updated status of the service, it implements a step of paying a provider of the service and, if applicable, releasing the staked incentive. Again, these steps can for example be autonomously and automatically implemented by the smart contract of the blockchain, which helps to improve their speed of performance compared to some techniques of the prior art, and thus constitutes an interesting incentive guarantee for the service provider.

According to yet another feature, such a method also comprises steps, implemented by a smart contract of the blockchain, of:
receiving a service offer;
recording the service offer in the blockchain.

In this way, the originator of a service request is assured that the conditions associated with a service offer cannot be changed after the offer has been made, which constitutes an additional guarantee.

The development also relates to a node belonging to a blockchain network, configured to execute a smart contract of the blockchain. Such a node comprises:
at least one processor; and
at least one computer-readable memory coupled to said at least one processor and in which program code instructions executable by said at least one processor to implement the service provision method as described previously are recorded.

The development yet relates to a computer program product comprising program code instructions for implementing the method as described previously, when it is executed by a processor.

The development yet relates to a client device of a communication network, that comprises:
a module for transmitting a service request, the request comprising at least one service selection criterion and at least one quality of service rule;
a module for receiving at least one candidate service offer, that meets said at least one service selection criterion, and selected from among service offers recorded in a blockchain of the communication network on the basis of said at least one quality of service rule on the one hand, and of a history of services, associated with the candidate service offers, and recorded in the blockchain, on the other hand.

According to one aspect of such a client device, the transmission module is also configured to transmit values assigned to the service selection criteria for a provided service, intended to be recorded in the blockchain.

The development also relates to a provider device of a communication network, that comprises:
a module for transmitting a service offer comprising at least one service selection criterion and intended to be recorded in a blockchain of the communication network;
a module for receiving a contract binding a service request recorded in the blockchain and the transmitted service offer, selected from among service offers recorded in the blockchain, on the basis of at least one quality of service rule contained in the service request on the one hand, and of a history of services, associated with the provider device, and recorded in the blockchain, on the other hand.

The development also relates to a computer-readable storage medium on which is stored a computer program comprising program code instructions for implementing the steps of the service provision method according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the above-mentioned service provision method.

The above-mentioned corresponding client device, provider device, node and computer program have at least the same advantages as those provided by the service provision method according to the present development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows in the form of a synoptic diagram an architecture of the service provision system according to one embodiment of the development;

FIG. 2 shows in synoptic form a preliminary phase of instantiation of the platform connecting offers and needs according to one embodiment of the development;

FIG. 3 describes in the form of a synoptic diagram a phase of recording service offers in the platform connecting offers and needs according to one embodiment of the development;

FIG. 4 shows, in the form of a synoptic diagram, the steps implemented within the platform connecting offers and needs according to one embodiment of the development, when a client terminal transmits a service request;

FIG. 5 shows in the form of a synoptic diagram the steps implemented within the platform connecting offers and needs according to one embodiment of the development, after provision of a service;

FIG. 6 proposes a sequence diagram of the various interactions between the service provider, the principal and the platform connecting offers and needs according to one embodiment of the development.

### DETAILED DESCRIPTION OF CERTAIN ILLUSTRATIVE EMBODIMENTS

The general principle of the development is based on the use of a blockchain structure, in a communication network, to design a platform connecting customers and service providers, supporting a decentralised, transparent and/or objective assignment of service offers to the service requests submitted by the customers.

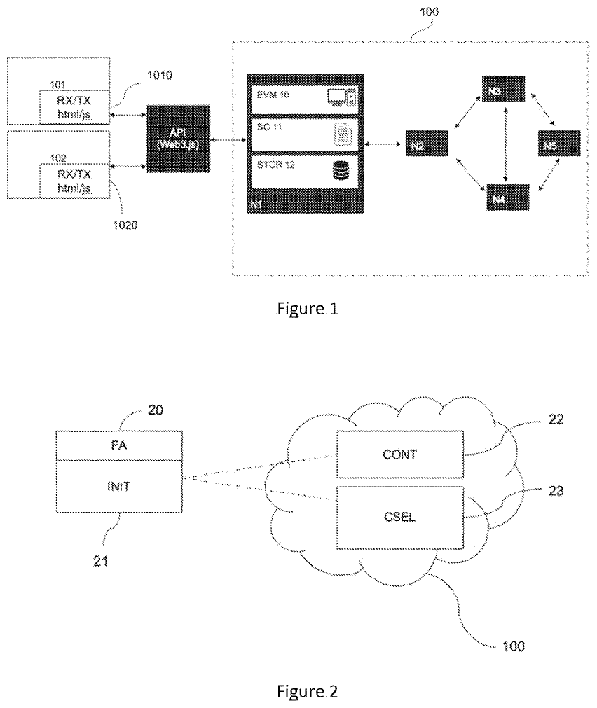

In relation to FIG. 1, the architecture of a blockchain-based service provision system according to one embodiment of the development is now presented. Such a system comprises a blockchain network 100, hereinafter also referred to as blockchain network 100, comprising a plurality of nodes N1 to N5 interconnected to each other. The structure of the node N1 is illustrated in more detail. Each node N2 to N5 has an architecture similar to that of the node N1, although this has not been detailed in FIG. 1 for the purposes of simplification. Thus, in some embodiments, the node N1 can comprise:
an Ethereum virtual machine EVM 10, which is the execution environment for smart contracts in Ethereum. It is recalled that Ethereum is a decentralised exchange protocol that allows the users to create smart contracts using a Turing-complete language;
a data storage area STOR 12;
the bytecode of the smart contract SC 11, i.e. the deterministic code executable on the blockchain network 100, whose variables can be stored on the network 100, and whose functions can be called with sufficient funds.

The backend of the service provision platform is thus decentralised, and resides in the smart contract SC 11 implementing a range of functions necessary to connect service providers and principals. As will be seen in more detail later, these functions that can be implemented by the smart contract SC 11 are the following:
Register( ), to record service requests or service offers in the blockchain network 100;
Filter( ), to filter service offers based on service selection criteria listed in a service request;
Sort( ), to sort the service offers that meet the criteria stipulated in the service request;
generateContract( ), to establish a contract between a service provider and a principal;
updateQoS( ), to record in said blockchain network 100 a quality of service corresponding to a provided service.

The users of the platform are, for example, the service providers 101 and the principals, or customers, 102. They can interact with the platform via their interface, or frontend. API (Application Programming Interface) requests enable interaction between the users 101, 102 on the one hand, and the smart contract SC 11 deployed on the blockchain network 100 on the other hand.

The client device of a principal 102 can comprise a transmission/reception RX/TX module 1020, configured to transmit service requests to the platform 100 as well as an assessment of a service provided, and to receive candidate service offers, selected by the platform 100. Such a client device can in particular comprise one or more processors, configured to execute program code instructions for transmitting and receiving such data, in particular in accordance with the HTML (HyperText Markup Language) and JS (JavaScript) programming languages.

The provider device of a service provider 101 comprises a transmission/reception RX/TX module 1010, configured to transmit service offers to the platform 100, and to receive contracts, established by the platform 100 when a service offer has been elected to respond to a service request from a client device 102. Such a provider device comprises in particular one or more processors, configured to execute program code instructions for transmitting and receiving such data, in particular in accordance with the HTML (HyperText Markup Language) and JS (JavaScript) programming languages.

The transactions listed and validated between the service providers 101 and the customers 102 can be stored as blocks in nodes N1 to N5 of the blockchain 100. Consensus rules can help limit malicious nodes, and identify invalidated transactions. Cryptographic rules can help ensure the pseudo-anonymity of transactions and users, and the authenticity of the providers' 101 service history. The term “node” can correspond to a software component as well as to a hardware component or a set of hardware and software components, a software component itself corresponding to one or more computer programs or sub-programs, or more generally, to any element of a program capable of implementing a function or set of functions.

More generally, a node N1 comprises a volatile memory (for example, a RAM memory), a processing unit equipped for example with a processor and controlled by a computer program, representative of the code instructions of the smart contract SC 11, stored in a read-only memory (for example, a ROM memory or hard disk). At initialisation, the code instructions of the computer program are for example loaded into the random access memory before being executed by the processor of the processing unit.

FIG. 1 only shows a particular one of several possible ways of realising a node N1, so that it executes the steps of the method detailed hereafter, in relation to FIGS. 2 to 6 (in any of the various embodiments, or in a combination of these embodiments). Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the node N1 is realised with a reprogrammable computing machine, the corresponding program (that is the sequence of instructions) can be stored in a removable (such as, for example, a floppy disk, CD-ROM or DVD-ROM) or non-removable storage medium, this storage medium being partially or totally readable by a computer or a processor.

According to one embodiment of the development, the connection platform 100 is intended to be generic, in the sense that it does not fit into a particular use case, but can find applications in various fields, such as agriculture, maritime logistics, road transport logistics, human services, industrial production, energy, etc. As illustrated in FIG. 2, it can therefore be necessary, before the platform 100 becomes fully operational, to provide time for instantiating the platform 100 to adapt it, for example, to the field of application desired by the user. In particular, the openness of the network 100 can be adjustable at instantiation (from the public blockchain to permissioned blockchains, and to private blockchains). Thus, this user can be a private stakeholder in the case of a private blockchain, or a consortium of stakeholders, in the case of a consortium blockchain. For example, the instantiation of the platform 100 can be performed by a consortium of transport companies, in the case of a platform dedicated to the transport of goods.

FIG. 2 illustrates this instantiation time by a user, qualified as “parent user”, who could be noted “Field Authority” FA 20. In the example shown above, this parent user FA 20 is the consortium of transport companies, which have previously agreed on the parameters for instantiating the platform 100.

Thus, during an initialisation phase INIT 21 of the platform 100 rules, the parent user FA 20 can for example specify:
the expected legal contract body CONT 22, for example a consignment note for the transport of goods. This contract body CONT 22 is stored in the smart contract SC 11. This is a standard contract, corresponding to the type of service provision the platform 100 will be dedicated to, that can be noted hereafter C;
the set P of objective selection criteria CSEL 23 that can be chosen by the principals 102 to submit a service request to the platform 100. The service providers 101 will have to fill in these various selection criteria when proposing a resource, or service offer, on the connection platform 100.

For example, in the example of a logistics application for transport companies, the selection criteria P can comprise:
the weight of the package to be delivered;
the volume of the package to be delivered;
the geographical area where the package will be picked up (for example, in the form of GPS (Global Positioning System) coordinates);
the geographical area where the package will be delivered (for example, in the form of GPS (Global Positioning System) coordinates);
the type of item of equipment used for delivery;
the price;
the elapsed time between package pick-up and delivery;
an identifier for the deliverer (their IMSI (International Mobile Subscriber identity), for example).

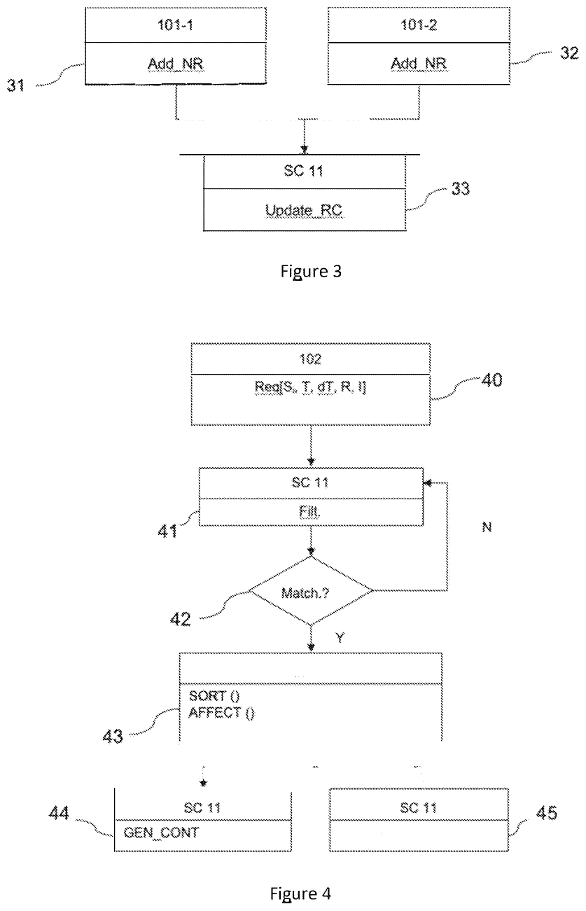

In the illustrated embodiment, after finalisation of this instantiation phase, the platform 100 is operational to proceed with a recording of the resources offered by various providers of goods or services 101, as illustrated by the synoptic diagram in of FIG. 3.

Indeed, the service providers 101 interested in and authorised by the parent user FA 20 can offer their services to the platform 100, so that they are referenced in a service catalogue recorded in the blockchain. This recording of the service offers in the blockchain constitutes a strong security for potential customers 102, as it guarantees that the service providers 101 cannot change the parameters of the service offer they propose (price, time, quantity, type of item of equipment, etc.) after contracting.

Thus, during an Add_NR step 31, the service provider 101-1 sends to the connection platform 100 a description of their service offer, according to the set P of the various selection criteria CSEL 23 defined during the instantiation phase of the platform; similarly, during an Add_NR step 32, the service provider 101-2 sends to the connection platform 100 a description of their service offer, according to the set P of selection criteria. For example, in the previous example of a logistics application for transport companies, the service provider 101-1 can, during the Add_NR step 31, describe a service offer that complies with the following selection criteria P:
weight of the package to be delivered: less than or equal to 150 kg;
volume of the package to be delivered: less than or equal to 2 m3;
geographical area where the package will be picked up: an area of 30 km radius around a city A;
geographical area where the package will be delivered: an area of 200 km radius around the city A;
type of item of equipment used for delivery: a hybrid or 100% electric truck equipped for the transport of fresh produce, identified by its model and OEM number;
price, expressed for example in € per kilometre;
elapsed time between package pick-up and delivery, for example a 48-hour guaranteed delivery;
identifier of the deliverer (their IMSI (International Mobile Subscriber Identity), for example);
certifications of the deliverer (e.g., transport of fresh produce/chemicals/international delivery authorisation, etc.).

Upon receipt, the smart contract SC 11 can record the offers received from the service providers 101-1 and 102-2 in the blockchain 100, in an Update RC step 33. The catalogue of resources recorded in the blockchain can specify, for at least some of them (for example, each one), the values of selection criteria P specified in the offers transmitted by the service providers 101. In addition, in some embodiments, a service provider 101 can have a pseudo-identity on the blockchain 100, that is associated with a history of services previously provided by them.

In some embodiments, the catalogue of resources and service offers illustrated in FIG. 3 can be updated continuously, throughout the duration of operation of the connection platform 100: new service providers can propose their resources; similarly, service providers already registered on the platform 100 can update their service offers, and in particular the values assigned to the various selection criteria P (for example, update of the price, the guaranteed delay, or the type of item of equipment).

When a customer (or principal) 102 wants to submit a service request, they can send a service request 40 to the platform 100, as illustrated in FIG. 4.

This service request 40, that can be noted Req[Sᵢ, T, dT, R, I], can comprise selection criteria [Sᵢ, T, dT], where:
Sᵢ is a subset of the selection criteria P defined during the instantiation of the platform 100, corresponding to the selection criteria chosen by the principal 102 to meet their needs,
T is the lifetime of the service request, and
dT is the retry frequency in case no service provider is allocated when the service request 40 is performed.

It should be noted that, as a variant, the retry frequency dT can be defined by the parent user when the platform is instantiated.

For example, among the set of criteria P that can be used to define the needs of the customer 102, the latter may be interested, in the formulation of their request, only in a subset Sᵢ, namely:
the weight of the package to be delivered: 40 kg;
the volume of the package to be delivered: 1 m³;
the geographical area where the package will be picked up: city A;
the geographical area where the package will be delivered: city B;
the price, which must be less than €100;
the type of truck, which must be electric;
the certifications of the deliverer, who must be authorised to transport fresh produce.

However, the delivery time and the identifier of the deliverer can be secondary to the customer 102, who may therefore not specify the value of some of these selection criteria CSEL 23 in their service request 40.

In addition, in some embodiments, the principal 102 can specify, in the service request 40, desired minimum quality of service, or QoS, rules, noted R. Let us note N the number of selection criteria CSEL defining the set P of selection criteria instantiated on the platform 100. A QoS rule R can be for example a Boolean combination of the selection criteria of P where ∀jϵ|[0,N] can be weighted by a factor Xjϵ[0,1]. For example, if the customer 102 is keen to ensure that the delivery deadline is met and the cost is kept under control, they can specify a QoS rule R, in which a weight of 1 will be assigned to the selection criteria of P corresponding to delivery time and price, and a weight of zero will be assigned to the other selection criteria of the set P.

In another example, a QoS rule R is constructed from two metrics (N=2), namely the experience of the deliverer, and the timeliness of delivery. For example, the customer 102 assigns a weight p1=0.6 to the metric Q1 relating to the deliverer's experience criterion P1 and a weight p2=0.8 to the metric Q2 relating to the timeliness of delivery criterion P2( ). The values of the deliverer metrics can both be normalised between 0 and 1. The QoS rule R can then be expressed as: R=(p1·Q1+p2·Q2)/N

If the metric related to the deliverer's experience Q1 is 0.7 and the metric related to timeliness of delivery Q2 is 1 (there has never been a delay), then the QoS score of the deliverer for the rule R is:

QoS=(p1·Q1+p2·Q2)/N=(0.6×0.7+0.8×1)/2=0.61

Finally, in some embodiments, the service request 40 can also contain optional incentives I, offered by the principal 102 to encourage the selected service provider to provide the best possible quality of service. These optional incentives I can for example take the form of a bonus for the service provider in the case where the customer is satisfied (for example, if the service is provided in advance), a call to an audit service in case of a dispute, or a deposit requested for taking on the service.

An example of an optional incentive is a deposit from the service provider when taking on the service (for example, a deposit of 0.3 times the value of the goods loaded into the truck). It can be staked, for example, until the requested service is performed.

If the delivery goes smoothly, the deposit can be returned in full to the service provider. Otherwise, assuming the service provider disappears with the goods, it can be paid automatically to the principal. Such an incentive thus encourages a favourable performance of the service.

Upon or after receipt of the service request 40, the smart contract SC 11 can apply a filtering 41 of the available resources in the resource catalogue updated in the step referenced 33, based in particular on the selection criteria Sᵢ specified in the request 40.

In some embodiments, if in a step 42 of identifying service offers compatible with the service request 40, no service offer listed in the catalogue recorded on the blockchain 100 matches all of the selection criteria Sᵢ specified by the customer 102, the smart contract SC 11 can reiterate the filtering 41 after a time interval dT, corresponding, for example, to the retry frequency in case the resource allocation to the customer 102 fails. According to embodiments, this iteration of the filtering 41 can be repeated a number M of times (M a strictly positive integer) or as long as the lifetime T of the service request has not expired. It will be noted that dT can be set to zero, either in the service request 40 or when the platform is instantiated. In this case, the filtering is not reiterated, and if no candidate service offer is identified in the step referenced 42, the service request is cancelled, and the principal 102 is notified by the platform 100.

If however, in the step 42 of identifying service offers compatible with the service request 40, the smart contract SC 11 identifies several service offers meeting the selection criteria Sᵢ specified in the service request 40, it can apply, in a step referenced 43, a multi-objective sorting (SORT( )) to obtain a profile (for example to obtain the best profile) from the set of identified service offers.

This sorting 43 can be based, for example, on at least some of the QoS rules R set by the principal 102. For example, for each of the candidate offers identified in the step referenced 42, the values of the selection criteria included in the calculation of the QoS rules R can be extracted from the log of events recorded in the blockchain 100 for the service provider 101 who transmitted the candidate service offer. The calculation of the QoS score assigned to candidate service offers is done, for example, by calculating a weighted average, from the selection criteria included in the QoS rule R. For example, if ten services have already been provided by the service provider 101 and recorded in a service history of this provider in the blockchain 100, all ten can be taken into account for the calculation of the QoS score assigned to them.

The sorting 43 of the QoS scores of the candidate offers can be obtained for example with the following formula:

SORT(Q)=DESCENDING_SORT(Σj pij Normj(Qij)∀iϵService offers])

More precisely, the QoS parameters for each of the candidate offers, for example for each of the deliverers (Normj(Qij)), are first normalised.

Once this normalisation is obtained, a weighted average is applied (Σj pij Normj(Qij)).

The resulting list is sorted in descending order (DESCENDING_SORT). The maximum score can then be extracted.

For example, a QoS rule R is considered, in which three metrics corresponding to three selection criteria P1, P2 and P3 are taken into account, and for which the associated weighting criteria are as follows: [p1=0.6, p2=0.4, p3=0.7].

It is assumed that four deliverers meet the selection criteria set by the principal 102 for a delivery of goods, and that for the three selection criteria P1, P2 and P3, each of the deliverers is scored as follows:
Deliverer 1=[Q₁₁=1, Q₁₂=2, Q₁₃=3]
Deliverer 2=[Q₂₁=2, Q₂₂=4, Q₂₃=2]
Deliverer 3=[Q₃₁=16, Q₃₂=4, Q₃₃=4]
Deliverer 4=[Q₄₁=6, Q₄₂=4, Q₄₃=4]

After normalisation of these QoS parameters, and weighting, the following QoS list (in %) is obtained for each of the deliverers 1 to 4 according to the above formula: [QoS1=31, QoS2=26, QoS3=62, QoS4=10].

Sorting 43 in descending order therefore comes to [QoS3, QoS1, QoS2, QoS4].

Thus, for at least some (for example, all) of the candidate service offers, a quality of service score (for example, QoS3 for deliverer 3) is calculated on the basis of the values that have been assigned to the various selection criteria P, for example in the context of services previously provided by the service providers, and whose assessment has been recorded in the blockchain 100. The service offers can be sorted on the basis of this quality of service score.

In a first embodiment variant, the candidate service offers sorted in this way (Deliverer 3>Deliverer 1>Deliverer 2>Deliverer 4) can be sent by the platform 100 to the principal 102, who can then make a choice and elect the service offer they want to retain.

In a second embodiment variant, the election of the service offer is autonomous, and can be performed directly by the platform 100, that retains, for example, the offer with the best quality of service score (in the previous example, the deliverer 3).

Choosing one or the other of these variants depends on a rule that can be specified in the smart contract.

In some embodiments, when a candidate service offer has been elected, the smart contract 11 can generate, in a GEN CONT step 44, a contract C, binding the elected service offer to the principal 102. This contract C, can be generated, for example, from the contract template CONT that was chosen in the step referenced 22 of FIG. 2, during the platform instantiation phase. This contract C, is stored in the blockchain 100. In some embodiments, if the service request 40 included one or more optional incentives, they can be staked in a step referenced 45.

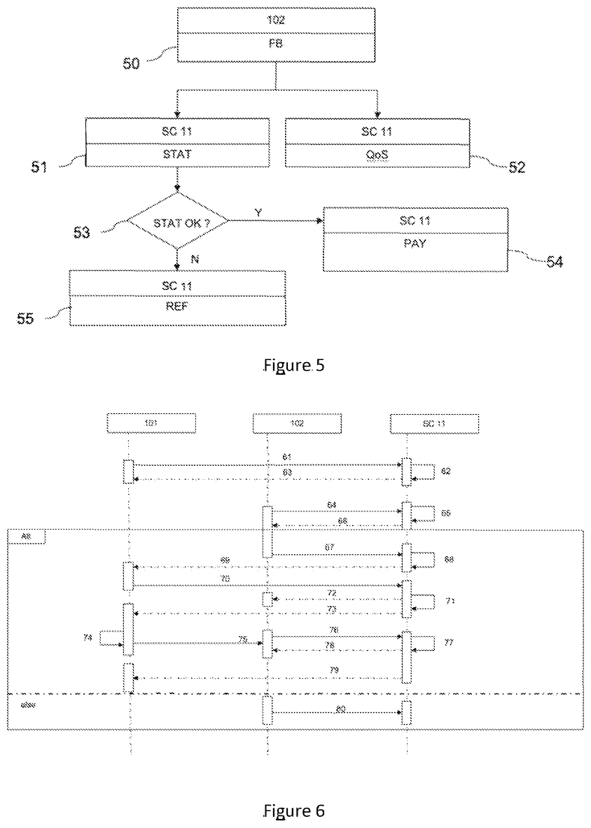

After this election and contracting phase, the requested service can be provided by the service provider 101. In some embodiments, during or after the service performance, the principal 102 can for example call the feedback function FB of the smart contract SC 11, in a step referenced 50, as illustrated in FIG. 5.

The principal 102 thus transmits to the platform 100 a certain number of parameters relating to the performance of the service provided, corresponding to values assigned to the service selection criteria P: actual delivery time, customer satisfaction score, integrity of the goods delivered, etc. For example, the principal 102 can indicate whether the packaging was damaged and, if applicable, provide photos of its condition on delivery.

The data transmitted by the principal 102 can be normalised before being recorded in the blockchain 100. In particular, this feedback of information can be performed by a number of connected objects (IoT) associated with the principal 102 or the service provider 101, that can provide the platform 100 with information on the service carried out, such as the performance time for example.

Such connected objects (IoT) can be, for example, a door opening detector, a temperature sensor, a moisture sensor, or a weight sensor, that provide information on the integrity and quality of the goods delivered (for example, on cold chain compliance for the transport of fresh produce). Thus, the temperature and moisture sensors can for example transmit to the platform 100 temperature and moisture diagrams corresponding to the information they have collected during the delivery period.

Such connected objects can also be RFID or 5G tags for identifying the batches of goods.

The function FB of the smart contract SC 11 can then perform two updates in the blockchain 100:
an update 51 of the required service status STAT; and/or
an update 52 of the quality of service QoS associated with the service provided by the service provider, for example by exponential moving average calculation.

It will be noted that the status of the task STAT corresponds to its performance in compliance with the rules specified in the smart contract SC 11 (positive status—e.g., on-time delivery of the right goods, and in compliance with a set of environmental and contextual constraints) or to its non-compliance (negative status—e.g., in the case where a threshold temperature is exceeded). The assessment of the status STAT is therefore dependent on the compliance with the terms of the contract.

Based on an assessment 53 of the status, the smart contract SC 11 can implement various actions.

If the status is positive, the smart contract SC 11 can, for example, in a PAY step 54, release the funds associated with the performance of the contract: the service provider 101 receives the payment for the service provided, and possibly the optional bonus I provided for in the service request 40, if these obtaining conditions are met.

Otherwise, the smart contract SC 11 can, for example, send, in a REF step referenced 55, the deposit of the service provider 101 to the principal 102, as compensation for the non-performance of the contract.

The course of the service is immutably traced on the blockchain 100. The information contained in these traces can be used, in the context of a future service request, in the provider selection mechanism previously described in relation to FIG. 4.

FIG. 6 illustrates, in the form of a sequence diagram, an end-to-end connection between a principal 102 and a service provider 101, in one embodiment of the platform 100. In the example of FIG. 6, it is considered that dT=0, i.e. the identification of candidate service offers that meet the selection criteria of the principal is performed only once: if there is no candidate, the request is cancelled.

FIG. 6 illustrates the various sequences of interaction between the service provider 101, the principal 102, and the intelligent contract SC 11.

In a step referenced 61, the service provider 101 registers their service offer with the platform 100, specifying the values they have set for the various selection criteria P instantiated on the platform. In a step 62, the smart contract SC 11 records them in the blockchain 100, and thus updates the resource catalogue associated with the platform 100. It sends, in a step referred 63, an acknowledgement to the service provider 101, to confirm that their service offer has been recorded.

In a step referenced 64, a principal 102 sends a service request 40 to the platform 100, specifying selection criteria, and quality of service rules, as previously described in relation to FIG. 4. The smart contract SC 11 then sorts, in a step referenced 65, the set of service offers recorded on the platform to identify the candidate offer(s) that meet the selection criteria specified by the customer 102. For each of them, it calculates a quality of service score, taking into account, for example, the history of the services recorded for each service provider in the blockchain 100. Thus, it sorts the candidate offers according to their QoS score, and sends this sorted list of candidate offers to the principal 102, in a step referenced 66.

It is assumed here that there are one or more candidate offers that can meet the need of the customer 102. Otherwise, the service request is cancelled, as per the step referenced 80.

The principal 102 elects one of these offers, in the step referenced 67, and informs the smart contract SC 11. As mentioned above, as a variant, the election can be performed automatically, directly by the smart contract SC 11, without the intervention of the customer 102.

The smart contract SC 11 then generates, in a step referenced 68, the contract governing the provision of the required service, and informs 69 the service provider that they have been selected to fulfil the request of the customer 102. The service provider confirms to the smart contract SC11 that they agree to provide the service for which their offer was elected, in a step referenced 70. Upon receipt of this agreement, the smart contract SC 11 initiates 71 the service provision process, and sends acknowledgements 72 and 73 to the principal 102 and the service provider 101.

In a step referenced 74, the service provider 101 performs the service for which they have been selected. They notify (75) the customer 102. The latter can then send their feedback 76 to the smart contract SC 11, giving for example an indication relating to their satisfaction (assessment, satisfaction score, etc.) with the service provided, and specifying for example the values assigned for this service to the various selection criteria P. The feedback 76 sent by the customer 102 can also consist in a classification performed by an artificial intelligence (AI) block.

Following the performance traces of a given service, a previously trained network can indeed assign a label to the service provider 101 (e.g.: beginner/intermediate/expert, etc.).

The smart contract SC 11 then updates, in a step referenced 77, the status of the service, and the quality of service QoS of the service provider 101. Depending on the status of the service, as explained above in relation to FIG. 5, it releases funds (step 79) to pay the service provider 101, if the status of the service is positive, or it forwards (step 78) to the customer 102 the deposit of the service provider 101, if the status of the service is negative.

Logistics is an application case of this connection platform 100 via smart contract SC 11. Let us take as an example a parcel delivery.

The principal 102 is looking for a deliverer 101 who is available for a given period T and whose truck is equipped to transport fresh produce. The order is critical, they want to use a reliable deliverer 101 who has had a minimum of delay in the past year. The deposit required from the carrier can be specified, as well as a tip if the delivery is in advance.

The principal 102 can therefore publish a delivery request 40 with this set of criteria, weighted as desired.

In this freight scenario, Sᵢ would be [M price, W minimum available weight, V minimum volume, E item of equipment, city A, city B], R would be [minimum delay, minimum distance, minimum carbon footprint]. The optional incentives would be [D deposit, t tip]. The sorting algorithm applies the selection criteria [Si, T] to the recorded resource base. If no resource matches the requested profile, a callback is performed after a period of time dT. These parameters are sent to the filtering function of the smart contract SC 11. Filtering becomes positive when at least one resource, in this case a carrier, meets the filtering criteria. If this is not the case, the request is put on hold and reinstantiated until date T at each period dT specified by the principal 102. The principal 102 has the possibility to cancel the connection process at any time.

Let us assume the filtering is positive. The resources are sorted according to their quality of service QoS score. Two possibilities should be considered:
The choice of the resource can be manual, performed by the principal
The choice of the resource can be autonomous. The resource with the best QoS score will be assigned to the request. With equal QoS scores, the assignment is performed randomly.

A standard e-CMR contract (legal document for the transport of goods by road) is generated on the blockchain 100. The deposit and the bonus can also be staked.

Once the delivery has been made, the principal 102 provides feedback on the delivery. The status of the task is updated, the QoS score (in this case the reputation) of deliverer 101 is updated. If the delivery went smoothly, the deposit and all or part of the bonus are sent to the deliverer.

1. A method of computer-implemented service provision in a blockchain of a communication network,
wherein the method comprises, implemented by a smart contract of the blockchain:
upon receiving at least one service request comprising at least one service selection criterion and at least one quality of service rule,
identifying at least one service offer that meets the at least one service selection criterion, referred to as candidate service offer, from among service offers already recorded in the blockchain; and
sending at least one of the candidate service offers, the at least one sent service offer being selected on the basis of the at least one quality of service rule, and of a history of services, the history of services being associated with the candidate service offers and recorded in the blockchain.

2. The method of computer-implemented service provision in a blockchain of a communication network according to claim 1, wherein the smart contract implements a reception of a plurality of service requests.

3. The method of computer-implemented service provision in a blockchain of a communication network according to claim 2, wherein the smart contract implements a reception of a plurality of service requests transmitted by a plurality of client devices of the communication network.

4. The method of computer-implemented service provision in a blockchain of a communication network according to claim 1, wherein at least one client device transmitting the at least one service request and/or at least one device providing at least one of the service offers recorded in the blockchain interact(s) with the smart contract via at least one Application Programming Interface (API) request using at least one function implemented by the smart contract and belonging to a following group:
a function for recording at least one service request and/or at least one service offer in the blockchain;
a function for filtering recorded service offers according to at least one service selection criterion comprised in at least one service request;
a function for sorting service offers that meet the at least one selection criterion comprised in at least one service request;
a function for establishing a contract between a device providing at least one of the service offers and a client device transmitting at least one of the service requests; and
a function for recording in the blockchain a quality of service corresponding to a provided service.

5. The method of computer-implemented service provision in a blockchain of a communication network according to claim 4, wherein the functions of the smart contract implement consensus rules.

6. The method of computer-implemented service provision in a blockchain of a communication network according to claim 1, wherein the sent service offers are sorted according to a quality of service score calculated for a candidate service offer, from the at least one quality of service rule, and the history of services, associated with the candidate service offer.

7. The method of computer-implemented service provision in a blockchain of a communication network according to claim 1, wherein the at least one quality of service rule is a weighted combination of service selection criteria recorded in the blockchain.

8. The method of computer-implemented service provision in a blockchain of a communication network according to claim 1, wherein the at least one service request also comprises a validity period of the at least one service request.

9. The method of computer-implemented service provision in a blockchain of a communication network according to claim 8, wherein the identification of candidate service offers is iterated until the end of the validity period, as long as no candidate service offer has been identified.

10. The method of computer-implemented service provision in a blockchain of a communication network according to claim 1, wherein a service of the history is recorded in the blockchain in association with a set of values assigned to the service selection criteria for the service.

11. The method of computer-implemented service provision in a blockchain of a communication network according to claim 6, wherein the quality of service score is calculated by utilizing the weighted or exponential moving average of values of the services of the history, based on the at least one quality of service rule.

12. The method of computer-implemented service provision in a blockchain of a communication network according to claim 1, wherein, after provision of the required service, the method comprises:
receiving and recording, in the blockchain, values assigned to the service selection criteria for the provided service; and
updating, in the blockchain, a status of the required service.

13. The method of computer-implemented service provision in a blockchain of a communication network according to claim 1, wherein the method also comprises, implemented by a smart contract of the blockchain:
receiving a service offer; and
recording the service offer in the blockchain.

14. A non-transitory computer-readable storage medium on which is stored a computer program comprising program code instructions for implementing the service provision method according to claim 1.

15. A node belonging to a blockchain network, configured to execute a smart contract of the blockchain,
wherein the node comprises:
at least one processor; and
at least one computer-readable memory coupled to the at least one processor and in which are saved program code instructions executable by the at least one processor to implement the service provision method according to claim 1.

16. A client device of a communication network, the client device comprising:
a transmission module configured to transmit at least one service request, the at least one service request comprising at least one service selection criterion and at least one quality of service rule; and
a reception module configured to receive at least one candidate service offer, that meets the at least one service selection criterion, and selected from among service offers already recorded in a blockchain of the communication network, on the basis of the at least one quality of service rule, and of a history of services, the history of services being associated with the candidate service offers and recorded in the blockchain.

17. The client device of a communication network according to claim 16, wherein the transmission module is configured to transmit values assigned to the service selection criteria for a provided service, intended to be recorded in the blockchain.

18. A provider device of a communication network, the provider device comprising:
a transmission module configured to transmit a service offer comprising at least one service selection criterion and intended to be recorded in a blockchain of the communication network; and
a reception module configured to receive a contract binding a service request recorded in the blockchain and the transmitted service offer, selected from among service offers already recorded in the blockchain, on the basis of at least one quality of service rule contained in the service request, and of a history of services, the history of services being associated with the provider device and recorded in the blockchain.
